(19) United States
(12) Patent Application Publication
(10) Pub. No.: US 2007/0130080 A1
(43) Pub. Date: Jun. 7, 2007

(54) Information processing system and license management method

(75) Inventor: Arihiro Kanda, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/601,698

(22) Filed: Nov. 20, 2006

(30) Foreign Application Priority Data
Nov. 21, 2005 (JP) 2005-335747

(51) Int. Cl. G06Q 99/00

(52) U.S. Cl. 705/59

(57) ABSTRACT

A queue management device (30A/30B) receiving jobs transmitted from a plurality of user terminals (10A/10B) stores the jobs to a queue corresponding to a base in which the user terminal is disposed. Each of the jobs to be stored includes a request of securing license. The queue management device requests a job processing device (41) to secure a license corresponding to a job read from the queue. The job processing device replies whether or not the license can be secured to the request from the queue management device. The queue management device transmits the job, to which the license is secured, to the job processing device. With this processing, a license can be fairly allocated to requests from respective users without depending on timing at which the license is requested.

### BACKGROUND OF THE INVENTION

1. Field of the Invention

The present invention relates to a license management technology necessary when an information processing device carries out software, and, more particularly, to a technology for managing licenses handled by a plurality of bases such as business affairs departments of a company.

2. Description of the Related Art

Heretofore, there are proposed technologies for automatically carrying out a license management to a plurality of information processing devices by a computer control without using manpower. Technologies of this type are disclosed in, for example, Japanese Patent Application Laid-Open Publication Nos. 2001-344031 and 2003-323224 described below.

In a method disclosed in Japanese Patent Application Laid-Open Publication No. 2001-344031, an information processing device is provided with a means for requiring to obtain a license and a means for controlling start of a license in association with operation of a GUI. According to the method, license release processing is automatically carried out on the completion of manipulation of the GUI carried out by an operator. Further, in a method disclosed in Japanese Patent Application Laid-Open Publication No. 2003-323224, the licenses managed by license servers disposed in respective departments of a company and the like composed of exclusive licenses that are exclusively owned by a self-department and shared licenses that can be used not only by the self-department but also by other departments.

According to the method of Japanese Patent Application Laid-Open Publication No. 2001-344031, a license to be used by the information processing device can be automatically requested and cancelled, and according to the method of Japanese Patent Application Laid-Open Publication No. 2003-323224, a license can be shared between a plurality of departments. However, in the conventional methods, there is a possibility that when license requests are issued from a plurality of bases, a license cannot be allocated in a proper sequence in response to the requests.

As to the above problem, there is contemplated a situation as shown in, for example, FIG. 12. In the illustrated situation, respective users of a base A and a base B transmit a request for license to a not shown license server and other bases. In this situation, it is assumed that when the base A issues a request for license at timing t1, no excessive license exist at the timing. It is also assumed that when the base A issues a request for license again at timing t2, no excessive license exists.

However, it is also assumed that although one license becomes usable at subsequent timing t3, the other base B occasionally issues a request for license at timing t3″ just after timing t3. In this case, there occurs such a circumstance that the license at timing t3 is allocated to the base B and no license is yet allocated to the base A which issued the license request prior to the base B. As described above, in the conventional systems, there is a possibility that a license cannot be obtained for a long period depending on a cycle in which a request for license is transmitted.

### SUMMARY OF THE INVENTION

Accordingly, an object of the present invention, which was made in view of the above problem, is to provide a method of properly allocating a license to a plurality of license requests.

An information processing system of the present invention includes a plurality of user terminals disposed to a plurality of bases, to which a predetermined number of licenses are previously allocated, transmitting jobs each including a request for license; a job processing device carrying out a job; and a queue management device storing the jobs transmitted by the plurality of user terminals to a queue of each of the bases and transmitting a job, to which a license is secured, to the job processing device, wherein the queue management device comprises a queue processing unit requesting the job processing device to secure a license corresponding to a job each time the queue management device reads the job from a queue; and the job processing device comprises a license secure processing unit replying whether or not the license is secured in response to the request from the queue management device.

A license management method of the present invention includes requesting from a queue management device storing jobs transmitted from a plurality of user terminals to a job processing device carrying out a job to secure a license corresponding to a job read by the queue management device; wherein the plurality of user terminals are disposed to a plurality of bases to which a predetermined number of licenses are previously allocated; replying from the job processing device to the queue management device whether or not the license requested from the queue management device is secured; and transmitting a job to which the license is secured from the queue management device to the job processing device.

According to the present invention, since a request for license from a user terminal is registered to the queue of the queue management device, a license can be fairly allocated to requests from respective users without depending on timing at which the license is requested.

### BRIEF DESCRIPTION OF THE DRAWINGS

FIG. 1 is a block diagram of an information processing system of an embodiment according to the present invention;

FIG. 2 is an explanatory view as to a license of the embodiment;

FIG. 3 is an explanatory view as to a license of the embodiment;

FIG. 4 is a block diagram showing functional arrangements of a queue management device and a PC of the embodiment;

FIG. 5 is a flowchart of queue processing of the embodiment;

FIG. 6 is a flowchart of license secure processing of the embodiment;

FIG. 7 is a flowchart of remote license secure agent processing of the embodiment;

FIG. 8 is a flowchart of remote license secure processing of the embodiment;

FIG. 9 is a flowchart of license continuation job execution processing and license hold job execution processing of the embodiment;

FIG. 10 is a flowchart of license release processing of the embodiment;

FIG. 11 is a flowchart of remote license forcible release processing of the embodiment; and

FIG. 12 is an explanatory view of a conventional license management system.

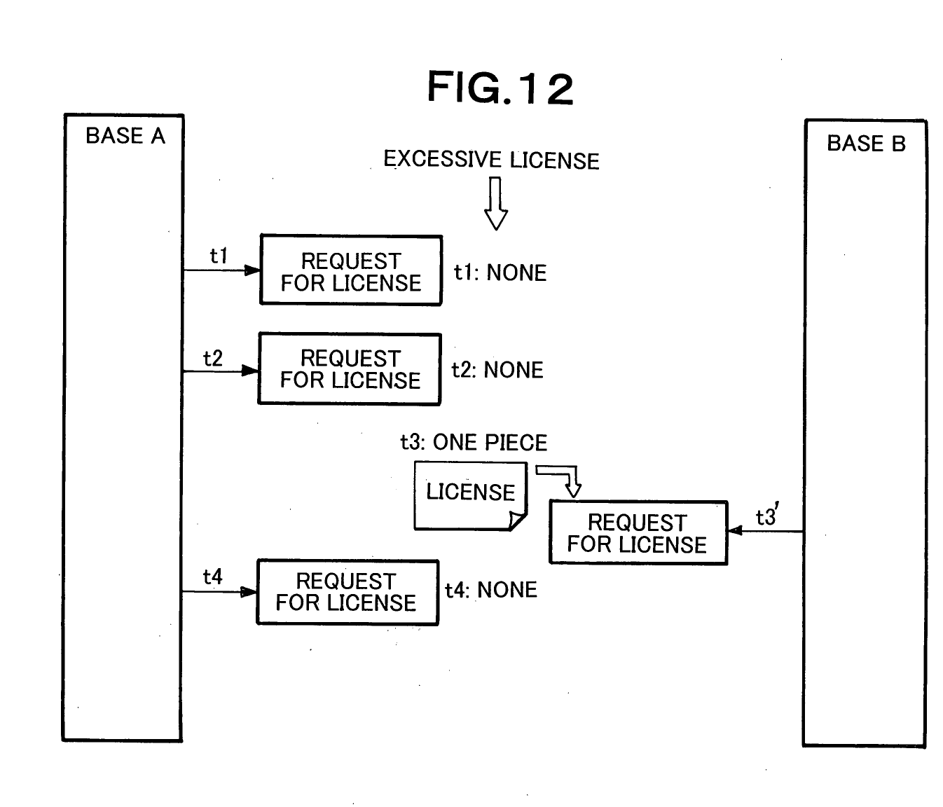

### DESCRIPTION OF THE PREFERRED EMBODIMENTS

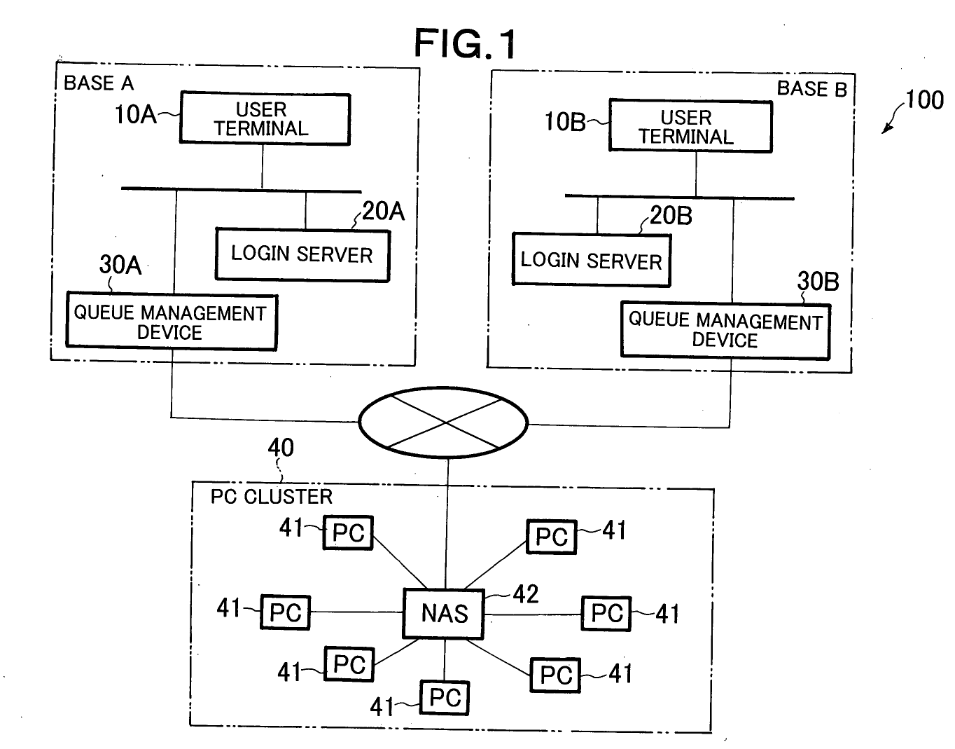

FIG. 1 shows an embodiment of the present invention. An information processing system 100 of the embodiment includes a user terminal 10 (10A and 10B) for transmitting jobs from a plurality of bases (A and B) such as business affairs departments, a login server 20 (20A and 20B) for receiving the jobs from the user terminal 10, a PC cluster 40 for dispersingly processing the jobs by a plurality of PCs 41 connected to a NAS (Network Attached Storages) 42, and a queue management device 30 (30A and 30B) for accumulating the jobs received by the login server 20 to a queue once and sequentially inputting them to the PC cluster 40. The PCs 41 of the PC cluster 40 are components corresponding to a job processing device of the present invention.

In the arrangement of the illustrated information processing system 100, the login server 20 and the queue management device 30 are disposed to each base. However, each one set of the login server 20 and the queue management device 30 may be disposed to a system and may be shared by the respective bases.

In the information processing system 100, the queue management device receives license requests, which are transmitted from the user terminal 10, from the login server 20 as jobs and sequentially stores them to a job queue. Further, the queue management device 30 achieves a function for allocating licenses necessary to the jobs thereto.

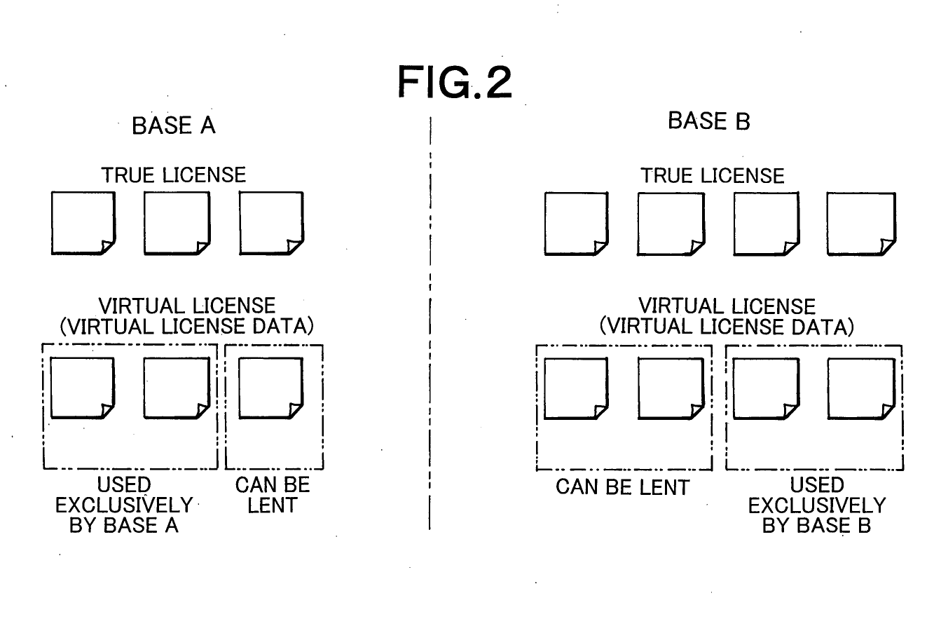

FIG. 2 schematically shows licenses managed by the queue management devices 30 of respective bases. The number of illustrated “true licenses” shows the number of licenses previously allocated to the respective bases, and the number of illustrated “virtual licenses” shows the number of licenses that may be varied by carrying out a job.

Further, as shown in FIG. 2, the number of “virtual licenses” of each base includes the number of “virtual licenses”, which are exclusively used by each base and the number of “virtual licenses”, which can be used not only by each base but also by the other bases, that is, which can be lent to the other bases by a remote control. In the illustrated example, in the base A, one of three licenses can be lent, and, in the base B, two of four licenses can be lent.

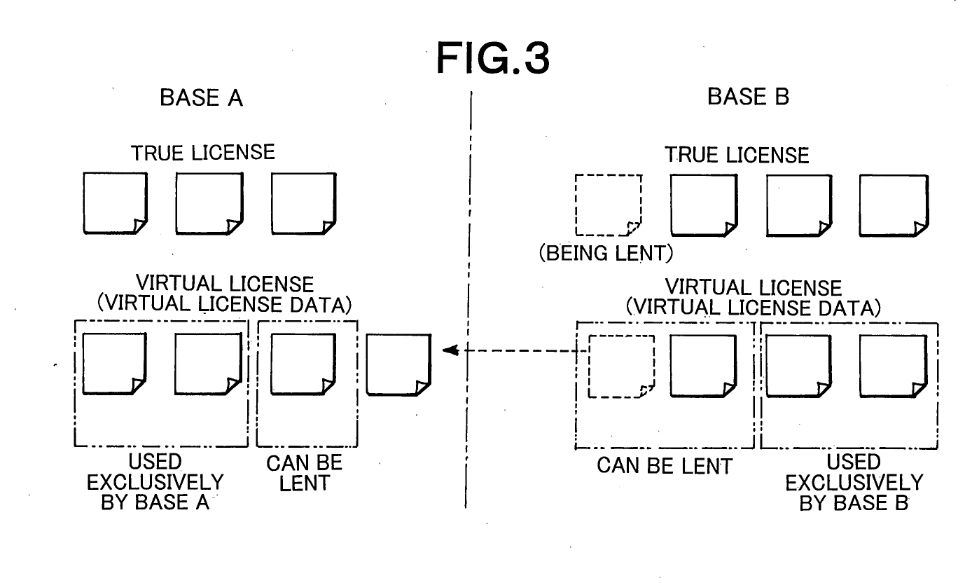

FIG. 3 shows an example that a certain base uses a license of other base by a remote control. The illustrated example shows a case that the base A, which uses all the three licenses originally held thereby, further uses one license of base B by the remote control. This means that the base A, to which the three licenses are originally allocated, temporarily uses four licenses.

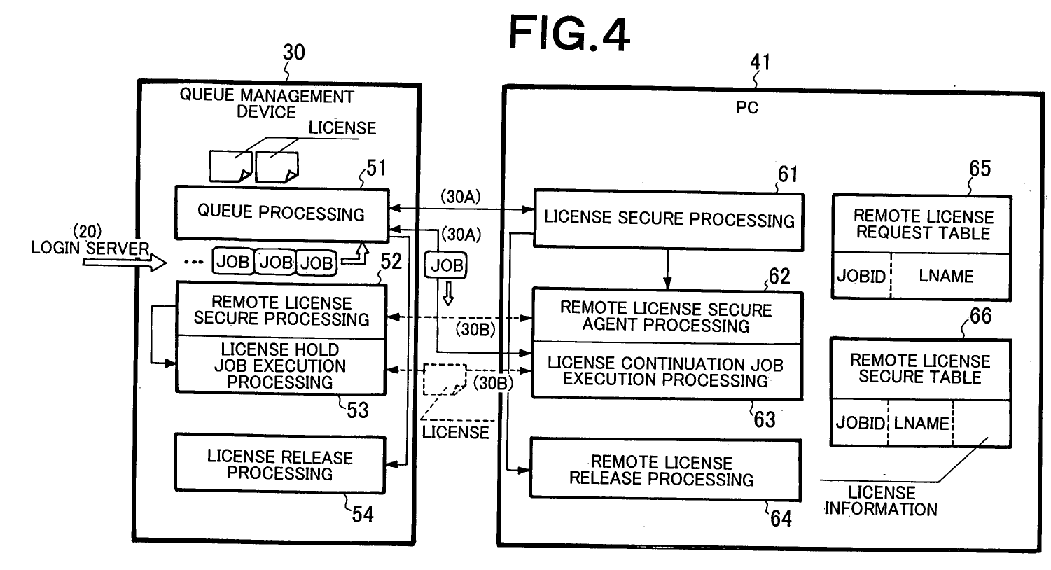

FIG. 4 shows functional arrangements of the queue management device 30 and the PC 41 of the PC cluster 40. These functional arrangements correspond to program modules mounted on the queue management device 30. It should be noted that solid arrow head lines and dotted arrow head lines of the arrows shown between the queue management device 30 and the PC 41 correspond to different bases of the queue management device 30. That is, for example, when the solid arrow head lines correspond to the queue management device 30A of the base A, the dotted arrow head lines correspond to the queue management device 30B of the other base B.

The queue management device 30 has, as the functional arrangement thereof, queue processing 51 for controlling a job queue for accumulating jobs, remote license secure processing 52 for receiving an inquiry as to an excessive license from a PC 41, license hold job execution processing 53 for causing the PC 41 to carry out a job while securing a license by the remote control, and license release processing 54 for releasing a secured license.

In contrast, as shown in FIG. 4, the PC 41 has license secure processing 61 for trying to secure a license requested from the queue management device 30, remote license secure agent processing 62 for searching a license that can be secured by the remote control, license continuation job execution processing 63 for carrying out a job while securing a license by the remote control, and remote license release processing 64 for releasing the license secured by the remote control.

Further, the PC 41 has a remote license request table 65 as a list of licenses to be secured by the remote control and a remote license secure table 66 as a list of actually secured licenses. These tables may be held by the NAS 42 of the PC cluster 40 and may be referred to by the PC 41 when necessary.

A job ID as an identifier of a job and an LNAME as a type of a license necessary to the job are recorded to the remote license request table 65. Further, license information is recorded to the remote license secure table 66 in addition to the job ID and the LNAME.

The license information is information showing from the queue management device 30 of which base a target license is to be secured and corresponds to the virtual license data of the present invention. When the target license is secured by the remote control, the IP address, the port number, and the like of the queue management device 30 to be accessed by remote are described to the license information. It shows that the license is secured by a relevant base and cannot be used by the other base that the license information is effectively set.

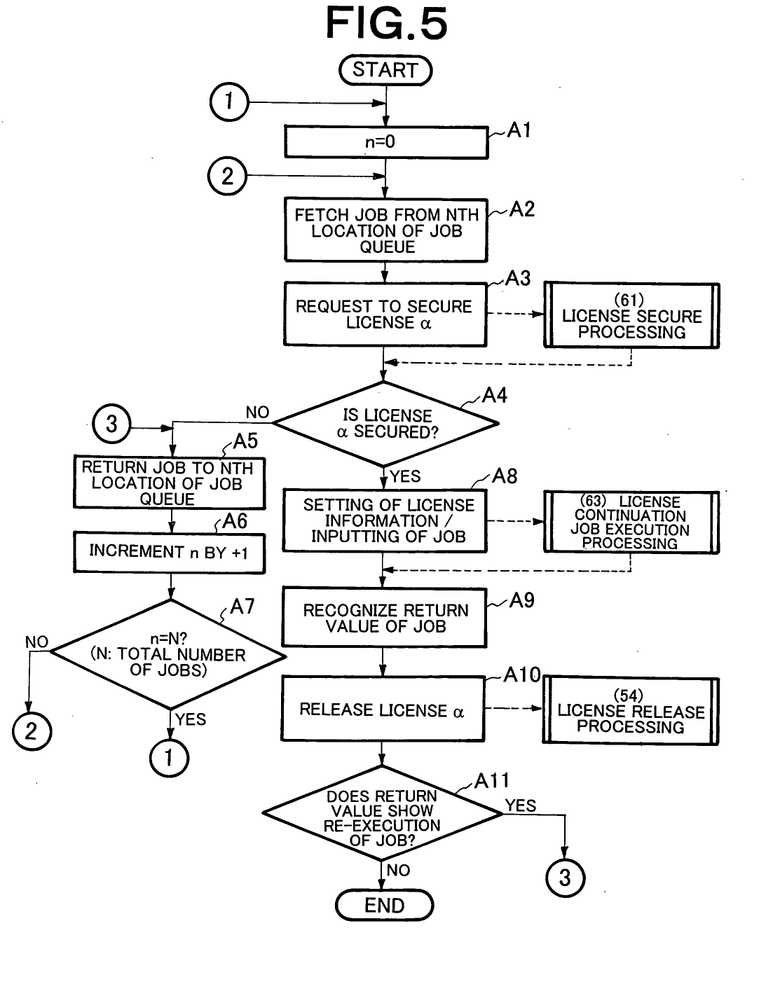

Next, an operation sequence of the information processing system 100 will be described below. First, the queue processing 51 will be described with reference to a flowchart shown in FIG. 5. As described above, the queue management device 30 receives license requests, which are transmitted from the user terminal 10, from the login server 20 as jobs and sequentially stores them to the job queue.

The queue management device 30 initializes a variable n to start processing of the job queue (step Al) and fetches the jobs sequentially from a job in a location “n=0” at the leading head of the queue one by one (step A2). When a fetched job is a request for a license α, the queue management device 30 inquires whether or not it is possible to secure the license α at the time to the license secure processing 61 of the PC 41 (step A3).

When the PC 41 fails to secure the license α as a result of the license secure processing 61 to be described later carried out by the PC 41, that is, when no excessive license α exists in any base at the time (step A4: No), the queue management device 30 returns the job to an nth location of the job queue (step A5). Then, the queue management device 30 increments the variable n by “1” to process a next job (step A6).

As described above, since the job, to which the license is not secured, is returned to the location of its original order in the queue, it is possible to continuously provide the job with an order of priority higher than that of the jobs newly stored in the queue.

In contrast, when the PC 41 succeeds to secure the license α (step A4: Yes), license information as to the license α is notified from the PC 41 to the queue management device 30. The queue management device 30 sets the notified license information to the job and inputs it to the PC cluster 40 to carry out the job (step A8). Further, the queue management device 30 increments the variable n of the job queue to process a next job (step A6).

When the license α is secured by the remote control, a target job is carried out by the PC 41 as a license continuation job to be described later. Then, an application body is started from the license continuation job.

On the completion of the job carried out by the PC 41, the queue management device 30 confirms a return value notified from the PC 41 as a result of processing of the job (step A9). Further, when the license α is a local license, that is, when it is a license of its base, the queue management device 30 releases the license α by the license release processing 54 to be described later (step A10).

The queue management device 30 determines whether or not the return value from the PC 41 indicates to carry out the job again (step A11). When the return value does not indicate to carry out the job again, the processings as to the job are finished. Further, when the return value indicates to carry out the job again, this means that the execution of the job by the PC 41 fails. In this case, the queue management device 30 returns the job to the nth location of the job queue (step A5).

The queue management device 30 repeats the above processings until the variable n of the job queue reaches the total number N of accumulated jobs, and when processings of the final “n=N” are finished, the queue management device 30 fetches a job from the location “n=0” again and processes it (step A7).

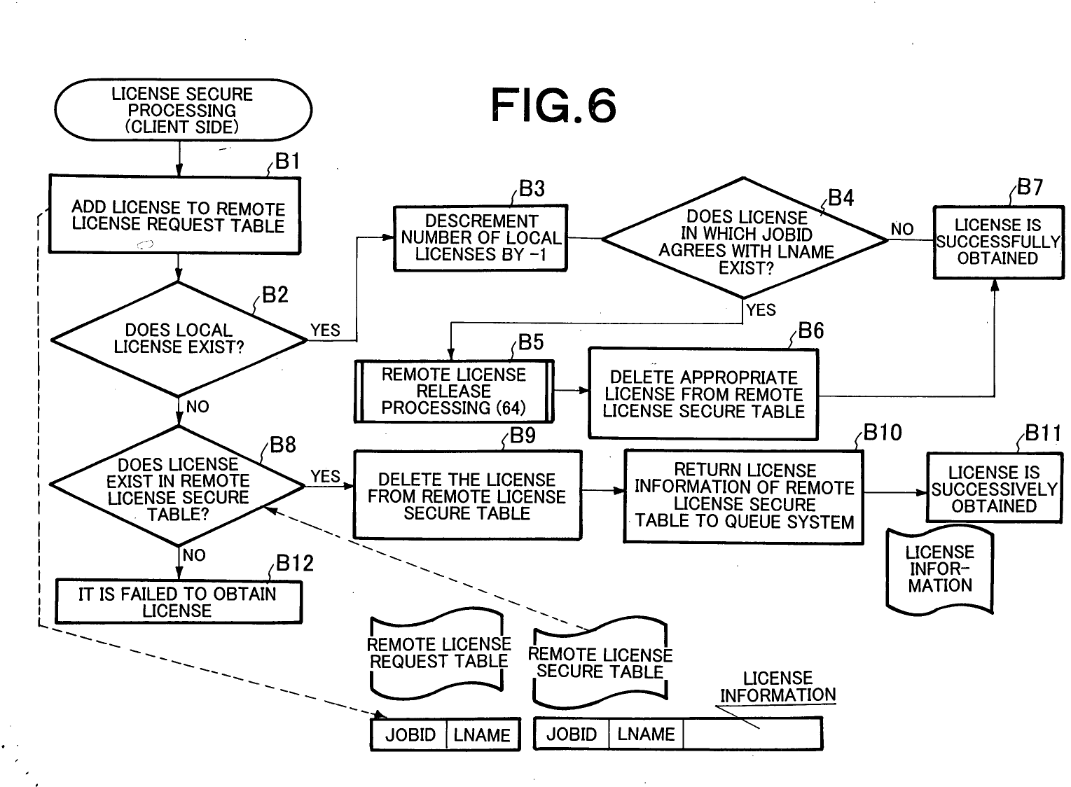

The license secure processing 61 carried out by the PC 41 will be described with reference to a flowchart shown in FIG. 6. In the following description, a PC 41 acts as a “client”, and a queue management device 30 of a base that lends a license to the PC 41 acts as a “server”.

As an example, description will be made assuming that a PC 41, which carries out a job from a queue management device 30A of a base A acts as the “client”, and a queue management device 30B of a base B that lends the license to the base A in remote acts as the “server”. In the above description, the base A is “local” when viewed from the PC 41.

On receiving an inquiry as to secure of the license α from the queue management device 30A (FIG. 5: step A3), the PC 41 as the client tries to secure the license α in both the local (base A) and the remote (base B). In the system, if the PC 41 succeeds to secure the license α in both the local and the remote, it employs the license α secured from the local.

First, the PC 41 adds the LNAME of the license α and the JOBID of a job that requires the license α to the remote license request table 65. (step B1). When the record is added to the remote license request table 65, the PC 41 carries out the remote license secure agent processing 62 to be described later in parallel with that it secures the license in the local.

Note that when the record of the LNAME and the job ID, which is intended to be added, already exists, it is not added. This is a case in which the record is left to the remote license request table 65 because the license is not secured to the target job in past.

To secure the license in the local, the PC 41 confirms whether or not an excessive license α exists in the base A (step B2). As a result, when the license α exists in the local, a count of the number of local licenses is decremented by “1” (step B3). The data of the number of local licenses is held in each base by the NAS 42 of the PC cluster 40.

Subsequently, the PC 41 confirms whether or not a record corresponding to the target job and the license α referring to the remote license secure table 66 (step B6). It means that the license is successfully secured by the remote control that the record exists in the remote license secure table 66.

When the license is successfully secured in the local as well as the record exists in the remote license secure table 66, the license α is secured in both the local and the remote. In this case, to release the license secured in the remote, the PC 41 carries out the remote license release processing 64 to be described later (step B5).

Further, as to the license to be released, the PC 41 deletes a target record from the remote license request table 65 and the remote license secure table 66 (step B6) and notifies that the license is successfully secured to the queue management device 30A (step B7).

Further, when no excessive license α exists in the local (step B2: No), the PC 41 refers to the remote license secure table 66 next and confirms whether or not the license α is secured by the remote control (step B8).

As a result, when the license is successfully secured in the remote, the PC 41 deletes relevant record from the remote license secure table 66 as well as transmits the license information shown by the record to the queue management device 30A (steps: B9, B10). As a result, it is notified to the queue management device 30A that the license α is successfully secured by the remove control. (step B11).

In contrast, when the license α cannot be secured in the remote at the time (step B8: No), the PC 41 notifies that it is failed to secure the license to the queue management device 30A (step B12). In this case, the target record of the remote license request table 65 is not deleted. That is, the record of the job, to which the license α cannot be secured this time, is left to the remote license request table 65. Accordingly, when the job is processed by the queue management device 30A again, the license α is secured to the job more preferentially than the other jobs occurred new.

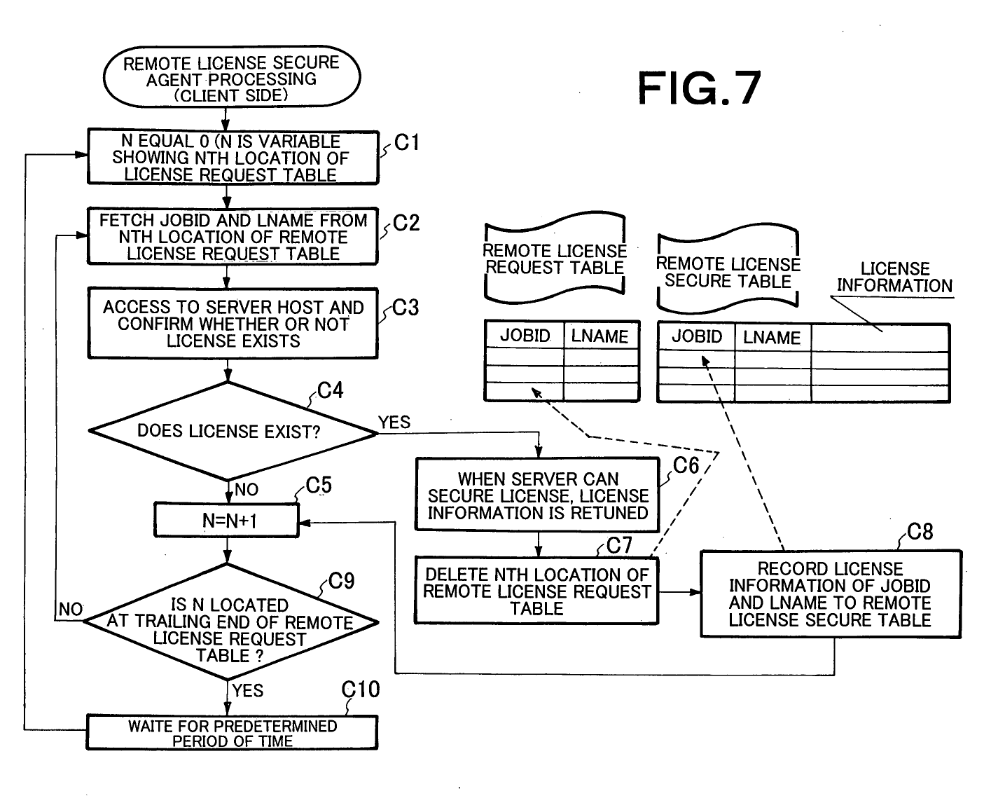

The remote license secure agent processing 62 will be described with reference to a flowchart shown in FIG. 7. As described above, the processing is carried out by the PC 41 in parallel with the license secure processing 61 (FIG. 6) in cooperation with the remote license secure processing 52 on the server side described later. Description here is also made assuming that a PC 41 relating to a base A acts as the “client” and a queue management device 30B of the other base B acts as the “server”.

In the remote license secure agent processing 62, the PC 41 initializes the variable N of the record of the remote license request table 65 to “0” (step C1) and sequentially reads Nth records of the table (step C2). Then, the PC 41 accesses the remote license secure processing 52 of the queue management device 30B acting as the server and inquires the base B whether or not an excessive license α exists therein (step C3). As a result, when no excessive license α exists on the server side (step C4: No), the PC 41 increments the variable N by “1” (step C5) to process a next record.

In contrast, the license α exists on the server side (step C4: Yes), the server sends a response notifying that the license α is reserved together with the information if it (step C6). On receiving the response, the PC 41 deletes the target record from the remote license request table 65 (step C7).

Further, the PC 41 records the license information and the job ID and the LNAME of a target received from the server to the remote license secure table 66 (step C8). The record recorded here is referred to by the license secure processing 61 described above (FIG. 6: step B8).

The PC 41 sequentially carries out the processings to all the records (step C9), and when all the processings are finished, the processings are started again from “N=0” after a predetermined time is waited (step C10).

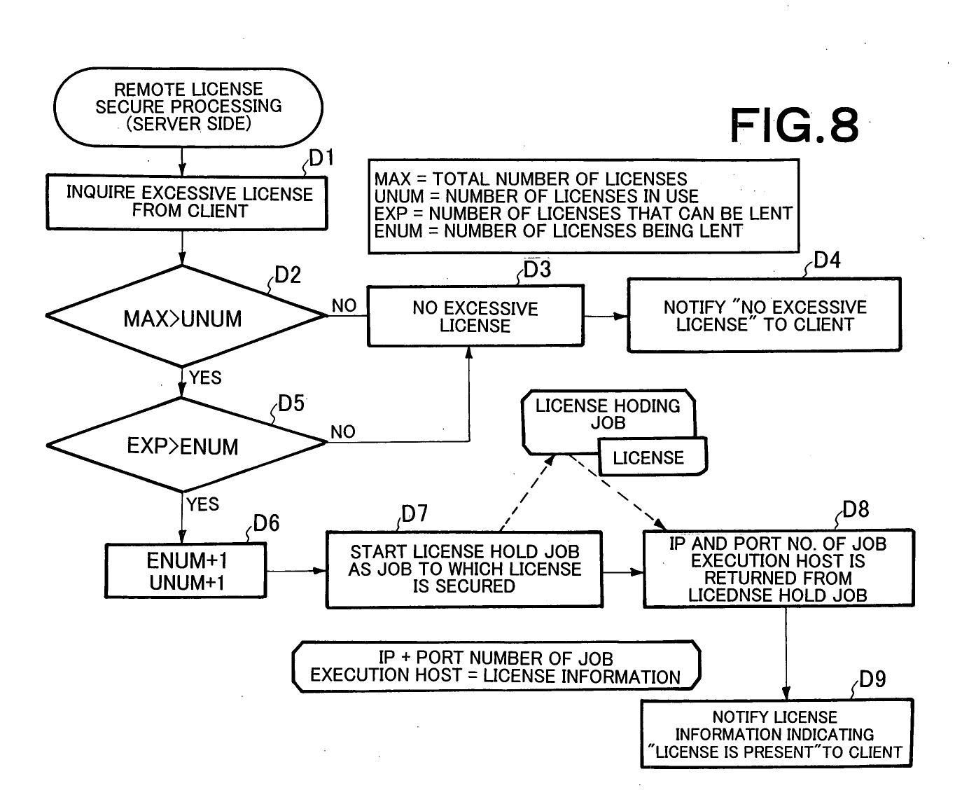

The remote license secure processing 52 carried out on the server side to the remote license secure agent processing 62 will be described with reference to a flowchart of FIG. 8. In the following description, the total number of licenses on the server side is shown by MAX, the number of licenses used at present is shown by UNUM, and the number of licenses that can be lent in the remote is shown by EXP, and the number of licenses being lent is shown by ENUM.

When the queue management device 30B of the base B acting as the server receives an inquiry (FIG. 7: step C3) as to the license α from the PC 41 (step D1), it determines “MAX>UNUM” as to the license α held by in the local (base B) (step D2). As a result, when a present status is not “MAX>UNUM”, the queue management device 30 recognizes that no excessive license α exists in the base B (step D3) and notifies it to the PC 41 (step D4).

In contrast, when the present status satisfies “MAX>UNUM”, the queue management device 30B further determines whether or not “EXP>ENUM” (step D5), and when it is not satisfied, the queue management device 30 recognizes that no excessive license α exists (step D3). Further, when “EXP>ENUM” is satisfied (step D5: Yes), the queue management device 30B recognizes that the excessive license α exists in the base B and increments “ENUM” and “UNUM” by “1” respectively to lend the license α to the client (step D6). With this processing, one license α of the base B is reserved to be lent.

Further, the queue management device 30B creates a license hold job to be described later and starts the license hold job after the license α reserved previously is allocated to it (step D7). The license hold job is carried out on the server side to handle the license α to be lent to the client as a license in use. As also described alter, the license hold job execution processing 53 supplies the IP address and the port No. of the queue management device 30B acting as the server the remote license secure processing 52.

When the IP address and the port No. of the queue management device 30B is recognized in the remote license secure processing 52 (step D8), the queue management device 30 notifies it to the client as license information (step D9).

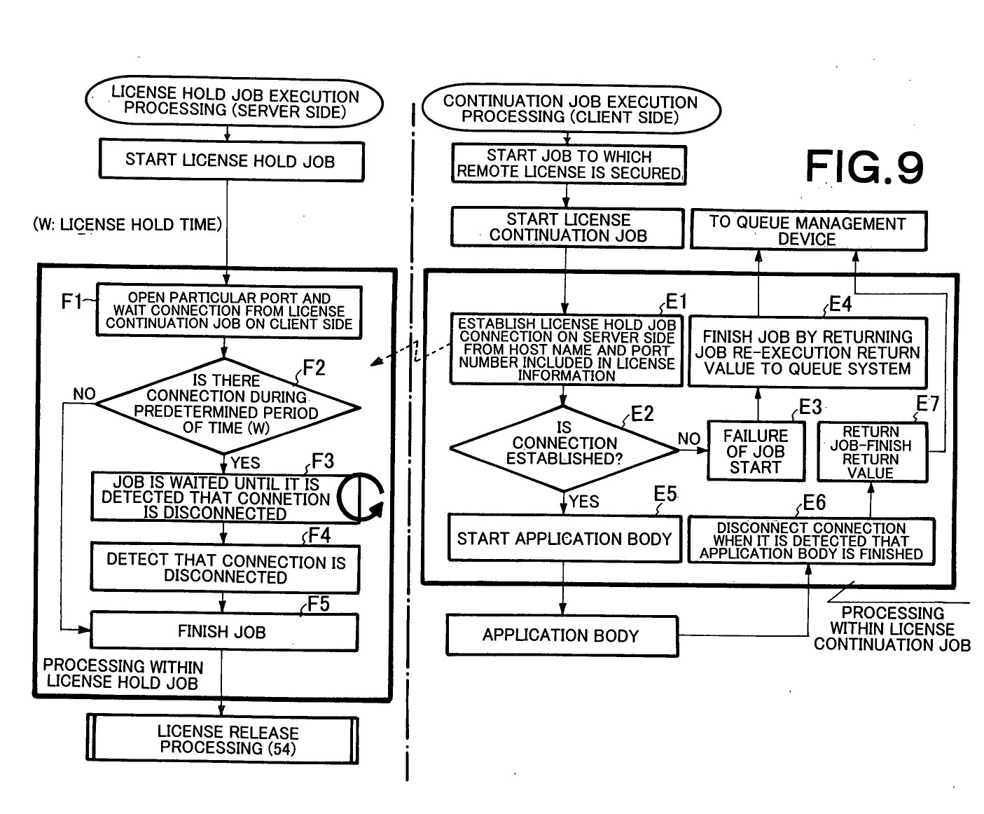

The license continuation job execution processing 63 on the client side and the license hold job execution processing 53 on the server side will be described with reference to a flowchart of FIG. 9. These processings are processings when the job to which the license is secure is carried out by the PC 41.

First, the PC 41 acting as the client starts a job input from the queue management device 30A of the base A as the license continuation job and fetches the license information set to the job. Then, the PC 41 accesses the queue management device 30B acting as the server using the IP address and the port No. shown by the license information and tries to establish a connection between it and the license hold job execution processing 53(step E1).

As a result, when it is failed to establish the connection due to communication circumstances and the like (step E2: No), the PC 41 recognizes that it fails to start the job (step E3) and transmits a return value showing that the job is failed to the queue management device 30A (step E4).

Further, when the connection is successfully established (step E2: Yes), the PC 41 starts and carries out application while maintaining the connection to the queue management device 30B (step E5). Although the license is secured well as execution of the application is permitted by maintaining the connection, it may be required to read also the license body depending on a type of the application. In this case, the PC 41 obtains the data of the license body from the queue management device 30B.

Thereafter, when the PC 41 detects that the application is finished, it disconnects the connection to the queue management device 30B (step E7). With this processing, it is notified to release the license α used by the remote control to the queue management device 30B. The PC 41 transmits a return value showing that the job is completed to the queue management device 30A (step E8).

During the above processings, the license hold job execution processing 53 is carried out as described below in the queue management device 30B acting as the server. As described above, the queue management device 30B starts the license hold job from the remote license secure processing 52 (FIG. 8: step D7).

When the license hold job execution processing 53 is started by the above processing, the queue management device 30B opens a predetermined port for receiving a remote control from the PC 41 and supplies the port No. of the port to the remote license secure processing 52. Further, the queue management device 30B waits for the PC 41 to issue a request for connection to the opened port for a predetermined period (W) (step F1).

As a result, when the predetermined period (W) has passed, that is, when the PC 41 issues no request for connection within the predetermined period (W) (step F2: No), the license hold job execution processing 53 is finished (step F5). When license hold job execution processing 53 is finished, the queue management device 30B releases the license α reserved by the remote license secure processing 52 described above (FIG. 8: step D6) by the license release processing 54 to be described later.

Further, when the PC 41 requests the connection within the predetermined period (W) (step F2: Yes), the queue management device 30B establishes the connection and maintains the connection until it is disconnected from the PC 41 (step F3). While the connection is maintained, the reserved license α is used by the PC 41 by the remote control.

Thereafter, when the queue management device 30B detects that the connection is disconnected from the PC 41 (step F4), it finishes the license hold job execution processing 53 (step F5) and releases the license α by the license release processing 54.

As described above, when the license is used by the remote control, since the two jobs carried out by the server and the client are connected to each other, the license can be reliably secured and released.

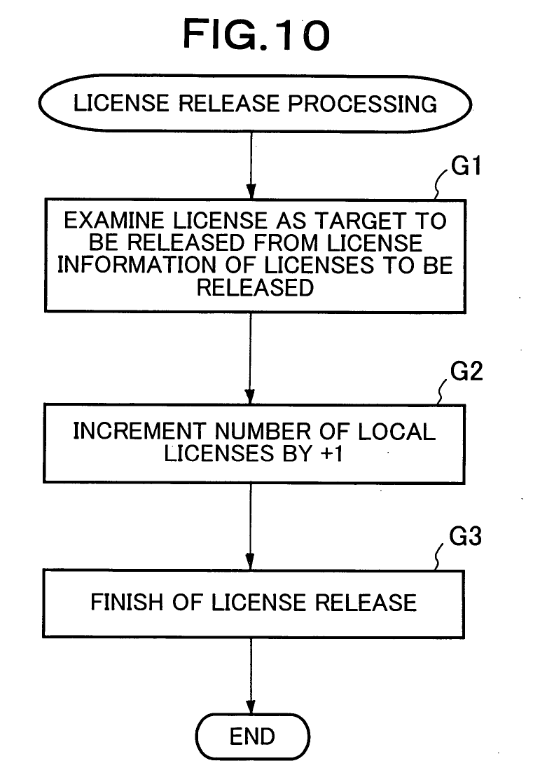

The license release processing 54 carried out by the queue management device 30 will be described with reference to a flowchart of FIG. 10. The queue management device 30 recognizes the license α to be released based on the license information (step G1) and increments the number of local licenses by “1” as to the license α (step G2). With this processing, the license α secured in the local is released and can be allocated to other jobs (step G3).

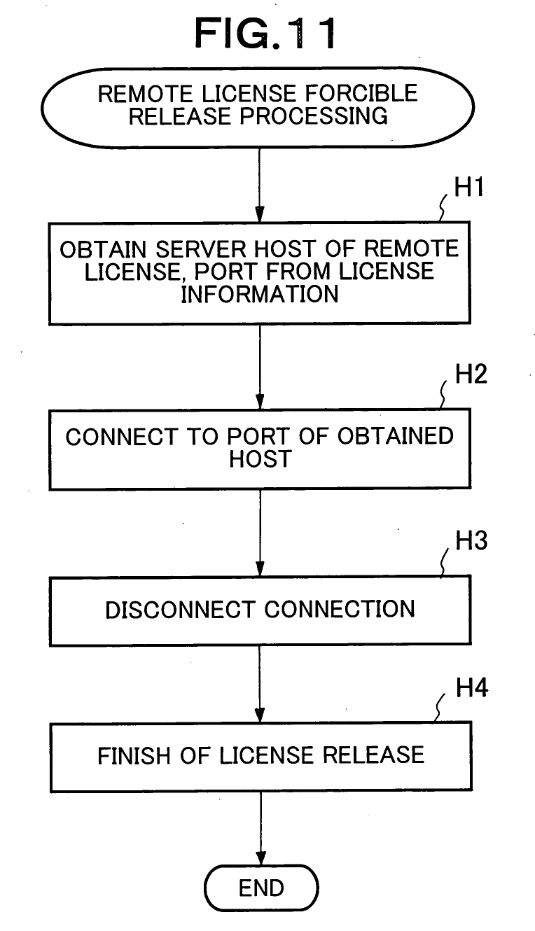

The remote license release processing 64 of the PC 41 will be described with reference to a flowchart of FIG. 11. The PC 41 recognizes the IP address and the port No. on the server side from the license information of the license α to be released (step H1). Then, the PC 41 accesses a target queue management device 30 (step H2) and disconnects the established connection (step H3). With this processing, the license α secured by the remote control is released (step H4).

According to the embodiment described above, since the information processing system 100 is arranged such that a request for license from the user terminal 10 is registered to the job queue for sequentially inputting a plurality of jobs to the PC cluster 40, the license can be fairly allocated.

Note that, as to handling of license when the embodiment is embodied, the total number of the “true licenses” of all the bases is as many as or less than the number of the PCs 41 on which software corresponding to the licenses is mounted. That is, when there are seven sets of target PCs 41, the number of the “true licenses” is seven or less.

In contrast, although it is preferable that the number of the “virtual licenses” be as many as the number of the “true licenses” as in the example shown in FIG. 3, it may be more than the number of the “true licenses”. As a result, a license can be allocated to a job which is not actually carried out as a reserved license. The maximum number of the “virtual licenses” that are actually effective, that is, the maximum number of the license information recorded to the remote license secure table 66 does not exceeds the number of the “true licenses”. Accordingly, even if “virtual licenses” more than the “true licenses” are created, they do not have an adverse effect on handling of a license.

With this arrangement, a wait time, which is caused that a license cannot be secured, is shortened, from which a job can be effectively processed. Further, since the number of the “virtual licenses” in the respective bases can be simply increased and decreased, a processing efficiency can be increased by adjusting “the number of virtual licenses” of the respective bases according to, for example, a progress state of a project.

Although the exemplary embodiments of the present invention have been described in detail, it should be understood that various changes, substitutions and alternatives can be made therein without departing from the sprit and scope of the invention as defined by the appended claims. Further, it is the inventor's intent to retrain all equivalents of the claimed invention even if the claims are amended during prosecution.

What is claimed is:

1. An information processing system comprising:
a plurality of user terminals disposed to a plurality of bases, to which a predetermined number of licenses are previously allocated, transmitting jobs each including a request for license;
a job processing device carrying out a job; and
a queue management device storing the jobs transmitted by the plurality of user terminals to a queue of each of the bases and transmitting a job, to which a license is secured, to the job processing device,
wherein the queue management device comprises a queue processing unit requesting the job processing device to secure a license corresponding to a job each time the queue management device reads the job from a queue; and
the job processing device comprises a license secure processing unit replying whether or not the license is secured in response to the request from the queue management device.

2. An information processing system of claim 1, wherein:
the job processing device further comprises a remote license secure agent processing unit determining whether or not a license is secured at a base different from a base corresponding to the request from the queue processing unit and supplying a result of the determination to the license secure processing unit; and
the queue management device further comprises a remote license secure processing unit receiving an inquiry from the remote license secure agent processing unit as to an excessive license and reserving the excessive license when it exists.

3. An information processing system of claim 2, wherein:
the job processing device further comprises a license continuation job execution unit carrying out the job from the queue management device while securing the license reserved by the remote license secure processing unit by a remote control; and
the queue management device comprises a license hold job execution processing unit replying to a connection for the remote control carried out by the license continuation job execution unit.

4. An information processing system of claim 1, wherein when the queue management device is notified from the job processing device that it is failed to secure the license, it returns the job to the queue by the queue processing unit.

5. An information processing system of claim 1, wherein the queue management device holds virtual license data for identifying the licenses allocated to the bases, and when the queue management device transmits a job to the job processing device, it transmits virtual license data corresponding to the job.

6. A license management method comprising:
requesting from a queue management device storing jobs transmitted from a plurality of user terminals to a job processing device carrying out a job to secure a license corresponding to a job read by the queue management device; wherein the plurality of user terminals are disposed to a plurality of bases to which a predetermined number of licenses are previously allocated;
replying from the job processing device to the queue management device whether or not the license requested from the queue management device is secured; and
transmitting a job to which the license is secured from the queue management device to the job processing device.

7. A license management method of claim 6, further comprising:
inquiring an excessive license in a base from the job processing device to the queue management device; wherein the base is different from a base corresponding to the request from the queue management device;
replying to the inquiry of an excessive license from the queue management device to the job processing device; and
reserving a license by the queue management device when an excessive license corresponding to the inquiry exists.

8. A license management method of claim 7, further comprising:
carrying out the job from the queue management device by the job processing device while securing the license reserved by the queue management device by a remote control from the job processing device to the queue management device; and
replying to a connection for the remote control, which is carried out by the job processing device, by the queue management device.

9. An information processing system of claim 6, wherein when the queue management device is notified from the job processing device that it is failed to secure the license, it returns the job to the queue.

10. A license management method of claim 6, wherein the queue management device holds virtual license data for identifying the licenses allocated the bases, and when the queue management device transmits a job to the job processing device, it transmits virtual license data corresponding to with the job.
